(19) United States
(12) Patent Application Publication
(10) Pub. No.: US 2022/0405973 A1
(43) Pub. Date: Dec. 22, 2022

(54) ANALYSIS OF URINE TEST STRIPS WITH MOBILE CAMERA ANALYSYS AND PROVIDING RECOMMENDATION BY CUSTOMISING DATA

(71) Applicant: Vivosens Inc, San Francisco, CA (US)

(72) Inventors: Miray Tayfun, Istanbul (TR); Aliasghar Noroozi, Ottawa (CA); Ali Atasever, GEMLIK (TR); Balim Bengisu Karacaoglu, Istanbul (TR); George Radman, Melbourne (AU); Gozde Buyukacaroglu, Istanbul (TR)

(21) Appl. No.: 17/821,936

(22) Filed: Aug. 24, 2022

Related U.S. Application Data
(63) Continuation-in-part of application No. 17/052,533, filed on Nov. 3, 2020.

(51) Int. Cl. G06T 7/90; G06T 7/00; H04N 9/77; G01N 21/27; G01N 21/78

(52) U.S. Cl. CPC G06T 7/90; G06T 7/0014; H04N 9/77; G01N 21/27; G01N 21/78; G06T 2207/10024; G06T 2207/20084; G06T 2207/20081; G01N 2021/7759

(57) ABSTRACT

A method for conducting a urinalysis is provided. The method includes receiving an image of a urine strip having a plurality of reacting areas configured to react with a predetermined urine parameter, and a plurality of reference regions each having a designated color; extracting, from each reference region, reference values representative of a detected color in the reference region; extracting, from each reacting area, color values representative of a detected color of the reacting area; conducting a regression analysis by determining least-squares of the reference values in accordance with prestored set of values corresponding to expected colors of each reference region; determining a color correction model by calculating root polynomial expansion of the least-squares; applying the color correction model on the color values by calculating root polynomial expansion of the color values to obtain normalized values; and determine level of the urine parameters in accordance with normalized values.

### FIELD OF INVENTION

The presently disclosed subject matter relates to a system for conducting urinalysis.

### BACKGROUND

Urinalysis is the physical, chemical, and microscopic examination of urine. It involves several tests to detect and measure various compounds that pass through the urine. When done on a frequent basis, urinalysis allows tracking changes in a person's body chemistry on a day-to-day basis.

Numerous analysis methods are used in detecting diseases in the field of medicine. Urine analysis is one of the analysis methods that is conducted most commonly and routinely as well as for almost every patient.

A method commonly used in urinalysis processes includes analyzing the urine spilled over a urine test strip or the color changes occurring by urine on the strip by dipping the urine test strips into a semi-closed container containing the urine. In the recognition systems in which the skilled persons in the art carry out the process without using any auxiliary equipment, the analysis method can be accomplished depending on the ability of observation of a skilled person in the art. In other words, a skilled person is always required for conducting urinalysis processes smoothly, thus it is not possible to be performed under any condition. Furthermore, as it is an empirical process, it is very susceptible to any possible fault.

There are certain nonempirical analysis methods as well, however a method that enables a urinalysis to be carried out without any extra costs in every environment has not been provided yet.

In a prior art United States patent document numbered U.S. Pat. No. 8,655,009B2, it is disclosed that the color-based reaction tests of the related biological materials are performed, in an uncalibrated environment, by capturing a digital image of a test strip together with a reference color chart adjacent thereto or a color chart on a strip. The biological materials used may include a urine, blood specimen and the like. The image data that represent the test pads in the test strips and the reference color blocks in the reference chart would be present on the picture to be subsequently taken, and would be compared to determine the color matches between the test pads and the related pixels. Based on this comparison process, a range of test results can be obtained, which are effectively capable of recognizing which color blocks from the reference chart is the most compatible with the test pads of the related test strip. The test results obtained can be subsequently delivered to users in a printed or visual manner. Alternatively, the test results can be kept to be taken later.

In another prior art United States patent document numbered US2015254844A1, a method for a calculating device with an imaging device to read the test strip of a specimen is disclosed. The method includes capturing an image of the test strip of the specimen. Wherein the image includes a reaction area, a color calibration area, and a temperature calibration area on the test strip of the specimen. A color of the reaction area is determined based on one or more than one color of the same. The color of the reaction area is associated with a color value of the color calibration area or the reaction area.

A further prior art Korean patent document numbered KR101124273 describes a urinalysis system that works with the image processing technology that enables a color change in the segments of a urine test strip and recognizing the color changed, and this method developed processes the color changes by converting them to a significant data. A server processes a urine recognition data, and thus it would be possible for a patient to use the urinalysis system conveniently.

When the prior art methods are taken into consideration, a need for developing an image processing system to be used to recognize a urine test strip and the area of said urine test strip and the segments therein, and also colors of every segment and their color changes with the cameras of intelligent devices as well as a urinalysis method configured such as to convert the data received from the image processing system to a significant data has risen.

### SUMMARY OF INVENTION

An aim of the invention is to provide a method of analyzing urine test strips by analyzing the same with a mobile camera.

Another aim of the invention is to provide a method wherein a strip with at least a reaction area and at least a frame area enclosing said reaction area is used.

A further aim of the invention is to provide an analysis method that is capable of

converting the analysis results obtained, following the analysis of urine test strips by analyzing with a mobile camera and converting said analysis results to a recommendation.

The invention relates to an analysis method of a urinalysis, comprising the following steps of:
pouring or urinating a urine sample of a user subjected to a urinalysis over at least reaction areas of a urine test strip such that it is in contact with said areas,
taking an image of the urine test strip enabled to contact with the urine by means of a display unit,
transmitting the image of the urine test strip taken, to a processing unit,
determining at least a reaction area of the urine test strip present on the image taken by using the data in a reference chart provided in a memory unit by the processing unit,
determining the color changes that has occurred in the reaction area of the urine test strip that is selected,
obtaining a urinalysis result by matching the data on the color changes determined with the data contained within the color scale of the memory unit in the processing unit,
receiving the data of the user subjected to the analysis in the user profile from the user data contained within the memory unit by the processing unit,
determining the recommendation in which the user data received and said urinalysis results are matched in a recommendation pool,
submitting the recommendation determined to the user.

Said urine test strip comprises at least a reaction area and at least a frame area enclosing the said reaction area.

Said mobile communication device comprises a memory unit containing the predetermined user data and the data on the reference chart, the color scale and the recommendation pool.

Said mobile communication device comprises an image capturing unit that allows an image of the strip to be taken.

Said mobile communication device comprises a processing unit that generates a urinalysis result by comparing the colors of the reaction area on the image of the urine test strip received from the image capturing unit with the data on the color scale received from the memory unit as well as detecting the matches.

The mobile communication device generates a recommendation, depending on the user data from the said recommendation pool, by matching the urinalysis results of the processing unit with the user data that it takes from the memory unit.

Thus, it would be enabled for the user to conveniently have a urinalysis in any environment with the help of mobile communication, and to receive a recommendation following the examination of their results.

Said recommendation pool is configured such as to be able to provide a recommendation depending on the urinalysis result and the user data. Thus, it is enabled to deliver users recommendation(s) that at least partially contributes to the health of the user based on the analysis results of the user and the data in the user profile.

Furthermore, it would be possible to minimize the mistakes on the image taken from the image capturing unit by preventing the background from flashing when processing the image by ensuring that the frame areas are the same color.

There is provided in accordance with an aspect of the presently disclosed subject matter a method for conducting a urinalysis. The method includes receiving an image of a urine strip having a plurality of reacting areas configured to react with a predetermine urine parameter, and a plurality of reference regions each having a designated color; extracting, from each reference region, reference values representative of a detected color in the reference region; extracting, from each reacting area, color values representative of a detected color of the reacting area; conducting a regression analysis by determining least-squares of the reference values in accordance with prestored set of values corresponding to expected colors of each reference region; determining a color correction model by calculating root polynomial expansion of the least-squares; applying the color correction model on the color values by calculating root polynomial expansion of the color values to obtain normalized values; and determine level of the urine parameters in accordance with normalized values.

The step extracting reference values can include converting the reference values to floating point values.

The step of conducting a regression analysis can include multiplying reference matrix including the reference values with an inverse of an expected matrix including the prestored set of values to obtain correction matrix representative of the color correction model.

The correction matrix can be calculated as:

exp(Mₜ)^{T}*(Mᵣ^{T})⁻¹

where Mₜ is a matrix of the reference values and where Mᵣ is a matrix of the prestored set of values. Note that M^{T} is the transpose of matrix M and M⁻¹ is the inverse of M.

The step of applying the color correction model can include multiplying the correction matrix with root polynomial expansion of the color values, wherein the color values are RGB values and the root polynomial expansion is defined as: exp(RGB)=(R, G, B, \sqrt{R*G}, \sqrt{G*B}, \sqrt{R*B})^{T}.

The step of applying the color correction model can be calculated as:

(M_{c}*exp(RGB)^{T})^{T}

where exp(RGB) is a matrix of root polynomial expansion of the color values and where M_{c} is the correction matrix.

The plurality of reference regions can include between five and thirty reference regions.

The method can further include neural networks training including comparing the normalized values with stored values and determining probability-weighted association between the normalized values and a predicted value of the urine parameters.

There is provided in accordance with yet another aspect of the present invention a system for conducting a urinalysis. The system includes a urine strip having a plurality of reacting areas configured to react with a predetermine urine parameter, and a plurality of reference regions each having a designated color; a mobile device configured to obtain an image of the urine strip and transmit the image. The system further includes a remote server configured for receiving the image from the mobile device; wherein the remote server includes a database including prestored set of values corresponding to expected colors of each reference region. The remote server further includes processing unit configured for: extracting, from each reference region, reference values representative of a detected color in the reference region; extracting, from each reacting area, color values representative of a detected color of the reacting area; conducting a regression analysis by determining least-squares of the reference values in accordance with the prestored set of values; determining a color correction model by calculating root polynomial expansion of the least-squares; applying the color correction model on the color values by calculating root polynomial expansion of the color values to obtain normalized values; and determine level of the urine parameters in accordance with normalized values.

The processing unit can be configured for converting the reference values to floating point values.

The processing unit can be configured for conducting a regression analysis includes multiplying reference matrix including the reference values with an inverse of an expected matrix including the prestored set of values to obtain correction matrix representative of the color correction model.

The correction matrix can be calculated as:

exp(Mₜ)^{T}*(Mᵣ^{T})⁻¹

where Mₜ is a matrix of the reference values and where Mᵣ is a matrix of the prestored set of values. Note that M^{T} is the transpose of matrix M and M⁻¹ is the inverse of M.

Applying the color correction model can include multiplying the correction matrix with root polynomial expansion of the color values, wherein the color values are RGB values and the root polynomial expansion is defined as: exp(RGB)=((R, G, B, \sqrt{R*G}, \sqrt{G*B}, \sqrt{R*B})^{T}.

Applying the color correction model can be calculated as:

(M_{c}*exp(RGB)^{T})^{T}

where exp(RGB) is a matrix of root polynomial expansion of the color values and where M_{c} is the correction matrix.

The plurality of reference regions can include between five and thirty reference regions.

The server can be configured neural networks training including comparing the normalized values with stored values and determining probability-weighted association between the normalized values and a predicted value of the urine parameters.

The server can include an image database including a plurality of classified images of the reacting area classified by levels of the of the urine parameters, the server is configured to extract characterizing features of the classified images and to determine level of the urine parameter in accordance with the characterizing features.

### BRIEF DESCRIPTION OF THE DRAWINGS

In order to understand the disclosure and to see how it may be carried out in practice, embodiments will now be described, by way of non-limiting examples only, with reference to the accompanying drawings, in which:

FIG. 1 is a representative view of a urine test strip and a mobile communication device used in the analysis method of urinalysis according to the invention;

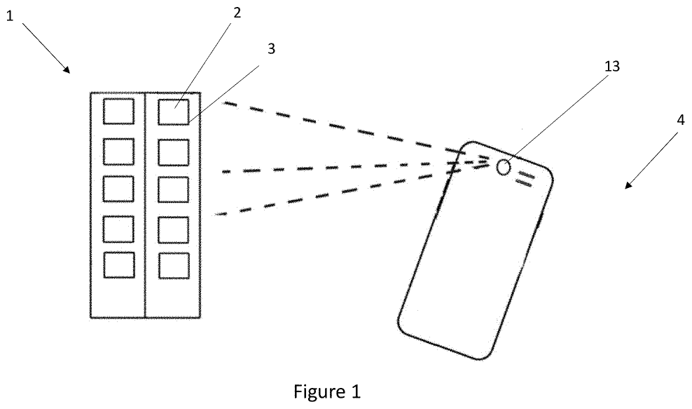

FIG. 2 is a representative view of the units containing the mobile communication device used in the analysis method of urinalysis according to the invention;

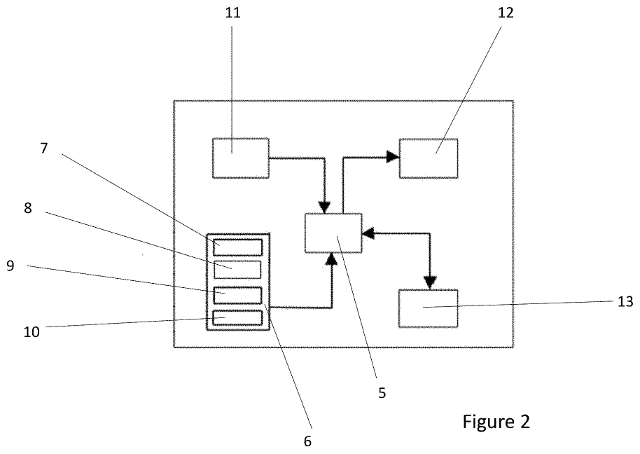

FIG. 3 is a top view of an example of a urine strip used in urinalysis according to the invention;

FIG. 4 is a flow chart diagram showing an example of the urinalysis according to an example of the invention;

FIG. 5 is a block diagram showing an example of a method for color correction according to an example of the invention;

FIG. 6 is a numerical representation of an example of the method of color correction of FIG. 5, and

FIGS. 7A-7D are images of a corrected pixel array of one sensor having a known parameter.

### DETAILED DESCRIPTION OF EMBODIMENTS

The components in the figures are separately numbered and the corresponding definitions of these numbers are as follows.

1. Urine Test Strip

2. Reaction Area

3. Frame Area

4. Mobile Communication Device

5. Processing Unit

6. Memory Unit

7. Reference Chart

### 8. Color Scale

9. Recommendation Pool

10. User Data

11. Communication Unit

12. Display

13. Image Capturing Unit

The invention relates to an analysis method of a urinalysis, comprising the following steps of:
pouring a urine sample of a user subjected to a urinalysis over at least one reaction area (2) of a urine test strip (1) such that it is in contact with the area,
taking an image of the urine test strip (1) enabled to contact with the urine with an image capturing unit (13),
transmitting the image of the urine test strip (1) taken to a processing unit (5),
recognizing the urine test strip (1) whose image is rendered by using the data in a reference chart (7) provided in a memory unit (6) by the processing unit (5) in the pattern of two columns and five rows, determining reaction areas (2) on the strip,
determining the color changes occurred in the reaction areas (2) of the urine test strip (1) selected,
obtaining a urinalysis result by matching the data on the color changes determined with the data contained within a color scale (8) of the memory unit (6) in the processing unit (5),
receiving the data of the user subjected to the analysis in the user profile from user data (10) contained within the memory unit (6) by means of the processing unit (5),
determining the recommendation in which the user data received and the urinalysis results are matched in a recommendation pool (9),
submitting the recommendation determined to the user.

A urine sample of a user subjected to a urinalysis is poured dripped or urintated over at least a reaction area (2) of a urine test strip (1) such that it can penetrate into the strip. Then, an image of the urine test strip (1) is taken with an image capturing unit (13) of a mobile communication device (4), such as a smart phone. The image taken is transmitted to a processing unit (5) by the image capturing unit (13). The processing unit (5) determines the urine test strip (1) by receiving the data in a reference chart (7) part provided in a memory unit (6) together with the image transmitted.

Locations of the reaction areas (2) on the image of the urine test strip (1) determined are detected by matching the data provided in the reference chart (7) with their mathematical coordinates.

According to an example the detection of the locations of the reacting areas is carried out by object detection machine learning model, and image processing.

The color change in the reaction areas (2) of the urine test strip (1) matched with the reference chart (7) is analyzed by using the method of RGB histogram in the processing unit (5). Then, the color occurred/unchanged in each reaction area (2) is compared with a different color space again and the colors are recognized by eliminating the characteristics such as flashing, light intensity based on the differences defined relative to distance. The color changes occurred in each reaction area (2) are listed. A urinalysis result is obtained by analyzing the responses occurred by the color change in the reaction area (2) with the predetermined data.

Then, a recommendation is submitted to the user by using the data provided in a recommendation pool (9), and comparing the urinalysis results with the user data (10) kept in the memory unit (6) containing the data related to the user subjected to the urinalysis.

The image capturing unit (13) used in the method is a camera. The urine test strip (1) used in the method comprises at least one reaction area (2). The reaction areas (2) are enclosed by at least one frame area (3). The reaction areas (2) are configured such as to change color by reacting with the urine that contacts to their surfaces. In an embodiment of the invention, the urine test strip (1) comprises a measuring area and a retaining portion having reaction areas (2) in two columns and five rows.

The frame area (3) in the invention is black in color. That the frame area (3) is black in color prevents flashing during the image rendering process. Furthermore, as the colors provided on the dark color are easy to perceive, the sensitivity of image rendering is promoted. Additionally, the reaction areas (2) have the frame areas (3) therebetween and the portion on which the reaction occurs is separated in parts. Thus, the reaction areas (2) are prevented from being disintegrated with the urine pressure and the image rendering is thereby facilitated.

A new design is developed with the analysis method of urinalysis according to the invention such that the faults of the urine test strip (1) in image rendering is minimized. In addition to this, a urinalysis can be carried out without any need for the high-quality image capturing units (13) thanks to the method developed.

The mobile communication device (4) used in the method is configured such as to communicate with other devices via a communication unit (11). The mobile communication device (4) has a display (12) that allows image display. The data provided from the display (12) is transmitted to a processing unit (5).

The processing unit (5) and a memory unit (6) contained in the mobile communication device (4) are associated such that they can make data exchange with each other. The memory unit (6) contains at least the reference chart (7), the color scale (8), user data (10) and data from the recommendation pool (9) therein. Moreover, the memory unit (6) is configured such as to be able to record data on the processing unit (5) and to have access to the prerecorded data.

The reference chart (7) contains the reference data of the physical characteristics of the urine test strip (1) including the size of the urine test strip (1), and the location map of each reaction area (2) and etc. The color scale (8) is used to generate a result by comparing the color changes occurred in the reaction areas (2) with the reference colors.

The user data (10) contain the prerecorded user profiles, and also, they are configured such that the data and profiles of a new user can be added as well. The user profiles in the user data (10) include the data on user's height, weight, age, possibility of any chronic disease, eating pattern, exercise rate, step count per day, blood glucose level, heartbeat rate, tension measurements, stress level, blood oxygen level, sleep patterns, period starting dates, information about pregnancy, menopose, etc. The recommendation pool (9) is a memory unit (6) part used in generating a recommendation by matching the data in the user profile contained in the user data (10) of the user subjected to the urine test with the urinalysis results.

In another embodiment of the invention, the urinalysis results of the user can be submitted to another mobile communication device (4), a server, etc. via the communication unit (11) of the mobile communication device (4).

In a further embodiment of the invention, the mobile communication device (4) can be electronic communication device such as a mobile phone, a tablet, a laptop computer, etc.

In a different embodiment of the invention, the display (12) can be a touch screen configured such as to allow the user to input data.

In another embodiment of the invention, the user data (10) include the user profiles containing various data for different users. Thus, it can be used in giving recommendation to the user by obtaining data on age, gender, chronic diseases and the like of the user subjected to the urinalysis.

One of the most important advantages of the invention is that it can be used in any environment and without any extra costs. For example, it can be conveniently used in the disadvantaged regions having limited health care services, houses, and small-sized hospitals without laboratories. This is particularly important related to people with a chronic disease and consistently in need for the urinalysis. Furthermore, the urinalysis results of the urine analyzed by using the data provided in the memory unit (6) by unskilled persons in the art can be obtained as well.

Moreover, thanks to the invention, the urinalysis results recorded on the user profiles can be monitored retrospectively. Thus, the user is easily able to have an access to his/her previous urinalysis results.

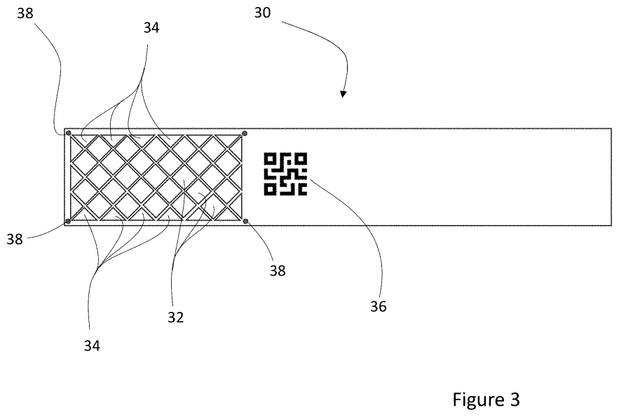

According to an example of the present application, as shown in FIG. 3, the strip (30) includes a plurality of reacting areas (32) each of which is configured to react with a predetermined urine chemical parameter, for example protein, glucose, blood, specific gravity, pH, magnesium, calcium, vitamin C, ketones, vitamin B, pregnancy, etc. The reaction of the chemical parameter with the associated reacting areas (32) causes the reacting area to change color. The strip (30) further includes a plurality of reference regions (34) each having a designated color, such that that the various reference regions (34) provide a range of colors. According to an example, the colors in the reference regions (34) are determined in accordance with specific values, such as RGB color codes and the like.

As explained hereinbelow, while the reacting areas (32) are configured to change color in response to a chemical reaction with the urine, the reference regions (34) are configured to maintain their predefined color regardless of the existence of urine and regardless of parameters of the urine. The reference regions (34) and the colors thereof are utilized to eliminate influences of light conditions on the strip (30), when the image of the strip is obtained. This way, when the image of the urine strip is sent by the user to a remote server, the colors of the reference regions (34) as shown in the obtained image, can be compared with the original colors of the reference regions (34). It would be appreciated by those skilled in the art, that the light conditions can include influences of the camera with which the image of the strip is obtained, the ambient light in the location where the image is taken, and the distance between the strip and the camera at the time the image is obtained. These light conditions can significantly affect the colors shown in the image, and thus provide distorted data related to the reacting areas (32).

Comparing the obtained colors in the image with the original colors facilitates the elimination of any lighting-related influences, which causes changes in the appearance of the colors of the reference regions (34). This elimination process includes detecting the overall influence of the lighting or the camera with which the image is taken and how this influence affects the appearance of each of the colors in the obtained image. That is to say, in some instances, the light conditions can have a higher effect on certain colors and a lesser effect on other colors. For that, the comparison of the colors of the reference regions (34) as appear in the obtained image with the real colors as shown on the strip should be conducted by comparing a range of colors.

Thus, the colors of the reference regions (34) are chosen such that they encompass a range of colors, similar to the colors of the reacting areas (32). Moreover, the reacting areas (32) are configured to adapt various shades and colors in response to chemical reactions with the urine. Consequently, the colors of the reference regions (34) are chosen in accordance with the expected range of colors and shades of the reacting areas (32), after the chemical reaction.

According to an example, the colors of the reference regions (34) are selected such that the colors are maximally dissimilar from each other in CIELAB color space, i.e., the colors are as different from one another as possible.

According to an example, the reference regions (34) are defined at the perimeter of the strip (30) such that the light influence can be detected with respect to any location on the strip. This is particularly useful in case a portion of the obtained image includes a shade, such as a shade caused by a light source disposed behind the person taking the image of the strip. Moreover, the color in each reference region (34) can be determined in accordance with the location of the reference region with respect to a certain reacting area (32a). In other words, in case a certain reacting area (32a) has a certain color and can adapt a certain range of colors in response to a chemical reaction, a reference region (34a) can be disposed in close proximity to this reacting area (32a) and can include a color which matches or at least similar to the color thereof.

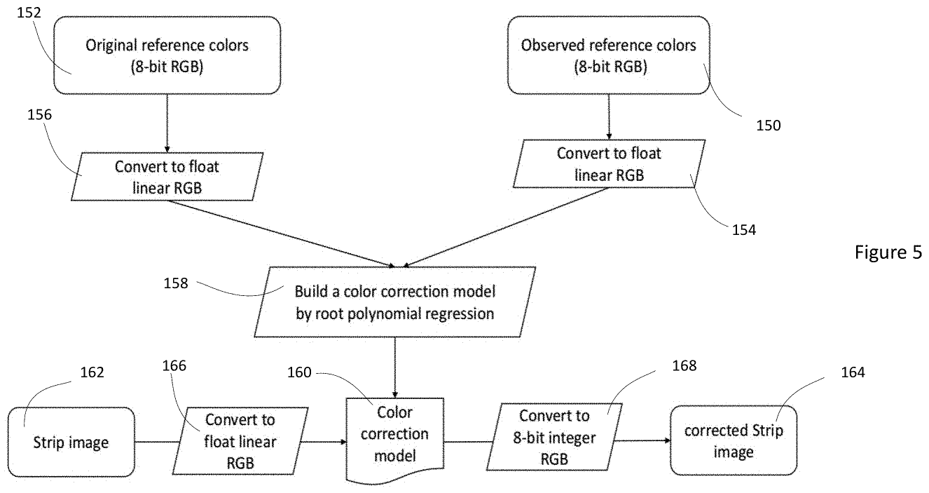

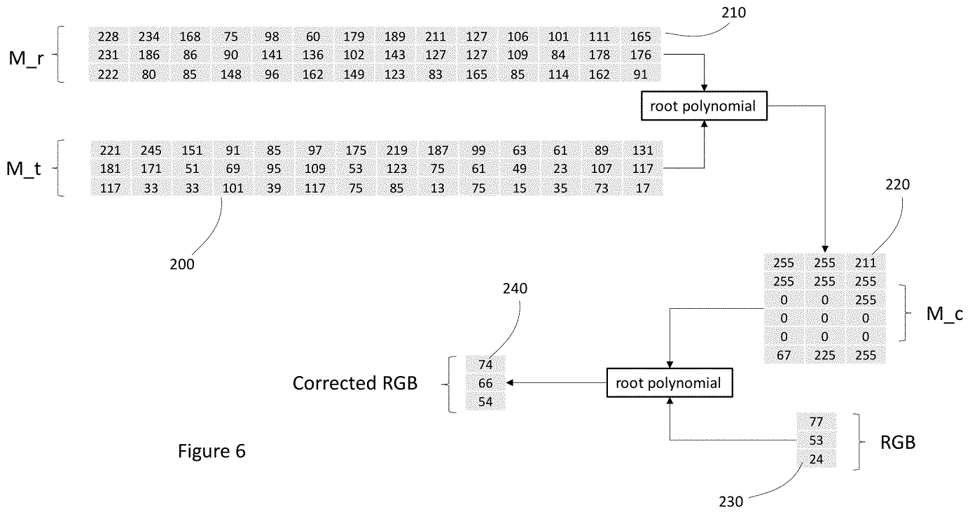

According to an example, the strip includes between five and thirty reference regions (34), such that the range of colors in the reference regions allows for forming a color correction model, for example, as described in connection with FIGS. 5 and 6. It should be noted that the strip may include more than thirtheen reference regions (34), depending on the number of reacting areas or the color varitions thereof.

The reacting areas (32) and the reference regions (34) can be disposed on the strip at an active portion of the strip, i.e., the portion of the strip which includes the data to be analyzed. The strip can further include locators (38) configured to indicate the location of the active area and identify each of the reacting areas (32) and each reference region (34). For example, the locators (38) can be graphical elements at the periphery of the active area, facilitating the image processing of the image of the strip. This way, during the processing of the image, the location of each reacting area (32) and each reference region (34) can be determined in accordance with the relative distance to the locators (38). Since each of the reference regions (34) has a specific predetermined color, identifying the corresponding reference regions shown on the image is required during the image processing stage. Thus, by using the locators (38) the location of each of the regions can be compared with the expected location of the corresponding region. Hence, the color in each of the reference regions (34) can be compared with the expected color in this specific reference region (34).

According to a further example, the strip can further include an identifier, such as a barcode (36), including data related to the strip, such as type, version, etc. This way, in case there are several kinds of strips, with various reference regions (34) or reacting areas (32), the version of the strip can be determined during the image processing stage.

According to an example, the strip can include a black background, such that the reference regions (34) and the reacting areas (32) are surrounded by black or other dark colors. Using a dark background allows better detection of the reference regions (34) and the reacting areas (32) in various environments. It is noted that the dark background facilitates training the server to build object detection models for auto-detection reference regions (34) and the reacting areas (32). In addition, the dark or black color in the background serves as an additional reference region along with other reference regions (34). Additionally, the dark background decreases the possible reflections which may be caused by the urine on the strip.

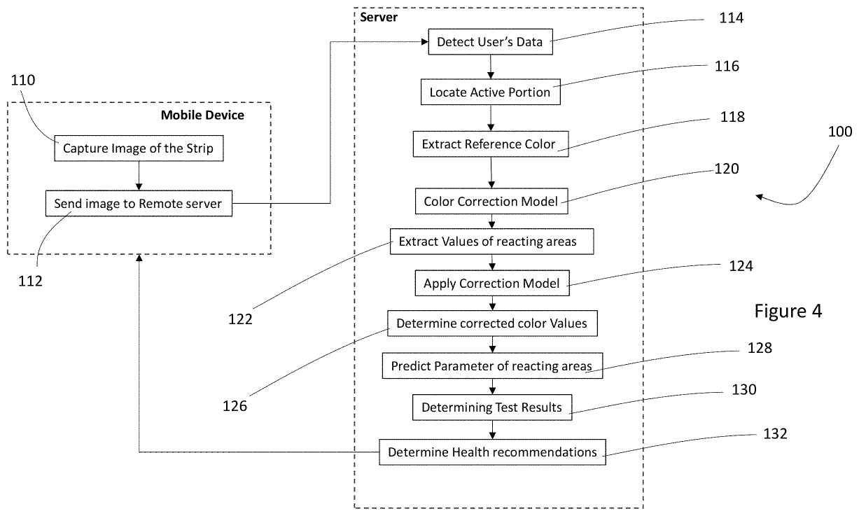

Reference is now made to FIG. 4, showing a flow chart representing a method (100) of a urinalysis according to the present invention. The method includes capturing an image of the urine test strip (block 110), which is carried out by a user using a personal handheld device, such as a portable phone, etc. The image can be taken immediately after urine is applied on the strip and can be captured regardless of the ambient, for example, in the bathroom where the urine test is conducted.

The user then sends the image of the strip to the remote server (block 112), for example, by using the internet capabilities of the handheld device. According to an example, the handheld device can be provided with a designated application allowing the user to easily capture the image of the strip and transmit of the image to the remote server. For example, the application can include an image-taking module that actuates the camera of the handheld device and provides guiding references on the display of the device so as to assist the user with properly locating the strip with respect to the camera. The application can be further provided with an initial verification module, verifying the image includes the entire strip, or at least the active portion thereof.

Next, the image is received by the server, and the user's data associated with the image is located (block 114). The user's data can be obtained by the enrollment of the user as a user in a database and can include any personal and relevant health information, such as age, background diseases, gender, height, weight etc. Accordingly, when the image of the strip is sent to the remote server, a user identification locator, such as a number, is sent as well. This way, the image of the strip can be stored in the server, and the data extracted from the image of the strip can be associated with the user. According to an example, in case the image is sent via a designated application on the handheld device, the application can be associated with the user's ID, such that any image or information sent by the application is automatically associated with the user.

The image is then processed to locate the image of the active portion of the strip (block 16), i.e., the portion of the image which includes the reference regions (34) and the reacting areas (32). Detection of the active portion can be carried out by detecting the locators (38) in the image. The locators (38) can be further used to determine the orientation of the strip shown in the image.

The detection of the strip can be carried out by a machine learning model that locates the strip in the images. The machine learning model can be an object detection neural network that has been trained, for example, in Google cloud machine learning. In addition to locating the strip and its orientation, the server can also be configured to detect the strip version, for example, by identifying a barcode (36) on the strip. Identification and location of the active area can be done using various features of the strip, such as strip shape, strip edges, sensors, barcode, logo, and any other features that differentiate a strip from other objects in the image.

In addition, as part of this step, the reference regions (34) and the reacting areas (32) can be counted and their exact location relative to the boundaries of the image can be determined. According to an example, the image is then sliced to portions, each of which including one of the reference regions (34) or of the reacting areas (32). This way, further processing of the image can be carried out with respect to each region separately and individually.

Further, the colors of each of the reference regions (34) is extracted from the image (block 118). The extraction can include assigning a digital value to the color in each of the regions, such as RGB values or the like. The values extracted for each reference region (34) are compared with the pre-stored values of the true colors of the same reference region. I.e., since each reference region has a predetermined color, the digital value of this color is pre-stored in the server and is compared with the values extracted from the obtained image. The extracted values and the corresponding pre-stored values are utilized to build a color correction model (block 120), which is a mathematical model representing the influence of the light condition on the obtained image, and how the light altered the color of each of the reference regions (34). Further discussion regarding the building of the color correction model is set forth herein below in connection with FIGS. 5-6.

The image is further processed to extract the values of the colors in each of the reacting areas (block 122), and to apply the correction model on the extracted values (block 124). Applying the correction model can include comparing the expected colors of each of the reacting areas with the extracted values. However, it is noted that the colors of the reacting areas are expected to change in response to the chemical reaction with the urine. Thus, the comparison with the expected colors is to the extent that the light condition affects the colors in the obtained image. Thus, the correction model is applied so as to allow determining the corrected color values of each of the reacting areas (block 126). I.e., the values of the colors of each reacting area after the influence of the light conditions were eliminated.

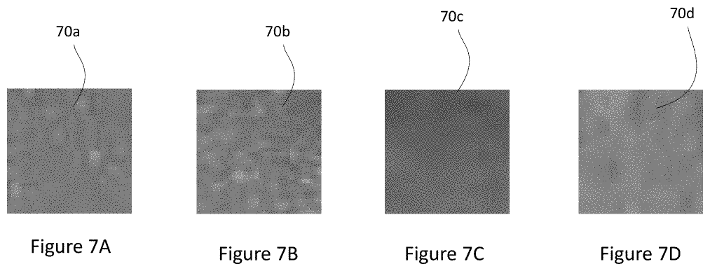

The corrected color values of each reacting area (32) are then used to predict the value of the urine parameter associated with the reacting area (block 128). The prediction of the urine parameter can be carried out by assessing the corrected color values of each reacting area and compression with pre-stored images of reacting areas for known urine parameter. In other words, each reacting area (32) may include a range of colors and a certain texture depending on the chemical reaction. Thus, the image of this reacting area includes a plurality of pixels, each of which has a certain RGB value. The correction model is applied to the entire pixel array of the reacting area, and the corrected color values are in fact, an array of pixels with corrected values. The prediction step thus includes comparing the entire array of corrected pixels with pre-stored images and assigning the urine parameter which corresponds to the obtained array. This step is explained hereinafter with reference to FIGS. 7A-7D.

The test results are then determined (block 130), and health recommendations are compiled (132). It would be appropriate that health recommendations are determined in accordance with the test results and other health and personal information of the user. In addition, the health recommendations are determined in accordance with the results of previous urine tests. For example, history data of previous test results of the user can be stored in the server and can be used to calculate a baseline specific to the user. This way, any deviation from the baseline can be detected, and appropriate health recommendations can be determined for the specific user.

Referring to FIG. 5, according to an example, the color correction model is built by root polynomial regression of the values extracted from the reference regions of the obtained image. These values are referred to hereinbelow as ‘extracted reference values’ (block 150). Initially, the original reference colors are retrieved from the memory of the server (block 152), for example, a set of RGB values of each of the reference regions on the strip. These RGB values, which are referred to hereinbelow as prestored values, represent the real colors on the reference regions as manufactured. It would be appreciated that the server can include a set of RGB values of various strips. Thus, at this stage, the version of the strip shown in the image must be first determined, for example, by a barcode.

Optionally, the extracted reference values and the pre-stored values are converted to float linear RGB values (blocks 154 and 156). The extracted reference values and the pre-stored values, or the corresponding float linear values, are then utilized for building a color correction model, for example, by root polynomial regression (block 158). At this stage, the regression analysis is conducted by determining least-squares of the reference values in accordance with the pre-stored values corresponding to the expected colors of each reference region. That is to say, the extracted reference values can be presented in a reference matrix and the pre-stored values can be presented in an expected matrix. The regression analysis can thus include multiplying the reference with an inverse of the expected matrix to obtain a correction matrix representative of the color correction model.

The correction matrix can thus be calculated as: M_{c}=exp(Mₜ)^{T}*(Mᵣ^{T})⁻¹ where Mₜ is a matrix of the reference values and where Mᵣ is a matrix of the pre-stored values. Note that M^{T} is the transpose of matrix M and M⁻¹ is the inverse of M.

The function exp represents the root polynomial expansion calculation, which for a matrix including RGB values is calculated as:

exp(RGB)=(R,G,B,\sqrt{R*G},\sqrt{G*B},\sqrt{R*B})^{T}.

The result of the above calculations in a correction matrix M_{c} which is the color correction model (block 160). The correction matrix M_{c} represents the change in the colors of the reference regions (34) as shown in the image, with respect to the colors of the corresponding reference regions (34) of the printed strip. Thus, the correction matrix M_{c} can be utilized to normalize the values of the colors in each of the reacting areas of the obtained image. In other words, the values of the colors in each of the reacting areas, referred to as color values, can be presented in a color matrix (block 162).

The correction matrix M_{c} is applied on the color matrix to obtain a set of normalized values (block 164), i.e., a set of color values of the reacting areas (32) without the influence of the ambient light shown in the obtained image.

In case the extracted reference values and the pre-stored values are converted to float linear RGB values (blocks 154 and 156), the same is applied to values of the color matrix, i.e., before applying the correction model (block 160), the values of the color matrix are converted to float linear RGB values (blocks 166). In this case, once the correction model (block 160) is applied to the float linear RGB values of the color matrix, the resulting values are converted back to 8-bit integer RGB (block 168). This way, the set of normalized values (block 164) is represented in 8-bit integer RGB. This step is explained hereinafter with reference to FIGS. 7A-7D.

Applying the color correction model can include multiplying the correction matrix with root polynomial expansion of the color matrix. For example, the correction matrix M_{c} can be used as follows:

(M_{c}*exp(RGB)^{T})^{T}

where exp(RGB) is a matrix of root polynomial expansion of the color values. The normalized values of the colors shown in the reacting areas (32) of the obtained image can then be used to determine the level of corresponding urine parameters.

As shown in the numerical example of FIG. 6, an M_t matrix (200) including reference values extracted from the reference regions of the obtained image, and an M_r matrix (210) including pre-stored values can be used to produce a correction matrix M_{c} (220) by using the root polynomial function. The correction matrix M_{c} can then be used to correct an RGB vector (230), extracted from one reacting area of the obtained image by applying again root polynomial function. The result would provide a corrected RGB vector (240), which represents the colors on the reacting area without the influence of the ambient light. Although in the present example, the correction matrix M_{c} is applied on an RGB vector, it would be appreciated that the correction matrix can be applied on a matrix of color values, i.e., a matrix including a plurality of RGB vectors extracted from a plurality of reacting areas of the strip.

As explained hereinabove, each reacting area includes an array of pixels, each having a certain RGB vector. Thus the correction matrix is applied to the entire pixel array, such that a plurality of corrected RGB vectors is obtained to form a corrected array of pixels. The corrected array of pixels is then used for assessing the urine parameter of the reacting area.

As indicated above in order to provide an optimal assessment of the required color correction, the reference regions on the strip can include thirteen colors, which is the optimal minimum number of reference colors to allow efficient removal of environmental light conditions, such as shadow, extreme sunlight, yellow and red colors imposed by the electric lights, etc. According to an example, the thirteen reference colors can be selected from 24 colors of Macbeth ColorChecker 2005.

Furthermore, according to an example of the invention, the root polynomial expansion can include an expanded polynomial degree, which controls the amount of correction applied to the images. Accordingly, the degree can be 1, 2, 3, or 4.

As indicated above, each reacting area (32) provides an array of pixels, each of which has certain RGB values. Similarly, the corrected RGB values are in fact, an array of pixels each of which has a vector of corrected RGB values. Accordingly, assigning the value of urine parameter associated with the reacting area includes assessing the entire pixel array and predicting the value of the urine parameter most closely corresponds to the obtained pixel array.

As shown in FIGS. 7A-7D, each corrected pixel array provides an image of one sensor. In the example of FIGS. 7A-7D, each one of the images 70a-70d represents an image of a reacting area configured to detect pH level in a urine test. As shown, each of the images has a certain texture of shades and varying intensity. It is noted that although the textures of each of the images 70a-70d are not the same, all the images are of a pH level 7.0. The differences between the textures in the images 70a-70d can be a result of other factors in the urine or in the specific strip. Thus, in order to predict the pH level of a corrected pixel array, the texture of the corrected pixel array can be compared against a plurality of images stored in a database. The comparison step can include detecting certain characterizing features on the image, which indicate the pH level. These characterizing features are determined by a machine learning process, as explained hereinafter.

The database includes a plurality of images of reacting areas classified by the value each image represents. For example, the database includes a plurality of images of a reacting area configured to detect pH level, and the images are classified by the actual detected pH level. This can be carried out, for example, by obtaining images of urine strips for each the values of the urine parameters are independently verified. Thus, for the present example, all the images 70a-70d show an image of reacting area for detecting pH level, for which the pH level was verified to be 7.0.

This way, when a new image of a pH reacting area is received, the obtained image can be corrected by utilizing the color correction model, and the corrected image is then classified in accordance with the texture shown in the image. This step can include neural networks training, including comparing the corrected images, including normalized values with stored images and determining a probability-weighted association between the corrected image and a predicted value of the urine parameters. In other words, the method can include machine learning models which predict values of corrected images of the reacting areas. The models can include image classification neural networks that have been trained to allow progressively extracting a better representation of the image content. This can be carried out by comparing lab results of a plurality of urine strips with corresponding images of the strips so as to build an accurate classification of the images sent by users.

According to an example, the machine learning process is carried out by using Session Initiation Protocol (SIP), which includes a model for each reacting area. Each model predicts the value of one of the reacting areas and can include Convolutional Neural Networks (CNNs).

When an image is uploaded to the SIP server, the server detects the strip, extracts reacting areas (also known as ‘sensors’), and performs color correction. At this stage, each color-corrected sensor is a 32×32 image (a set of RGB pixels). This image of the sensor is given as input to its corresponding model, and the model predicts the value of the associated urine parameter.

According to an example, a model is formed by utilizing thousands of lab images. These lab images are extracted using urine samples, for which values of the urine parameters are known. For example, in the case of protein that has 5 values: 0, 25, 75, 150, 500, thousands of strips can be used. Urine samples for which the protein level is known can be poured over the strips and images of the strips are taken and classified based on the known protein level. This way, the database includes thousands of images of protein reacting area for each of the protein levels.

Using machine learning methods, the images of the known protein level are classified and are used for future prediction of an image of a protein reacting area. In other words, the images of the reacting area with the known protein level are given as input to the training process. The output of the training process is a machine learning model for each reacting area.

While training a model, CNN automatically learns characterizing features which is crucial in differentiating images of each value. The characterizing features can be color ranges, how colors change across the reacting area, and possible shapes or textures created in the reacting area during the chemical reaction. These characterizing features are different for each value of the urine parameter. I.e., color ranges and color changes in images of protein level 0 are different from protein level 25.

Those skilled in the art to which the presently disclosed subject matter pertains will readily appreciate that numerous changes, variations, and modifications can be made without departing from the scope of the invention, mutatis mutandis.

1. A method for conducting a urinalysis, the method comprising:
receiving an image of a urine strip having a plurality of reacting areas configured to react with a predetermined urine parameter, and a plurality of reference regions each having a designated color;
extracting, from each reference region, reference values representative of a detected color in said reference region;
extracting, from each reacting area, color values representative of a detected color of said reacting area;
conducting a regression analysis by determining least-squares of the reference values in accordance with prestored set of values corresponding to expected colors of each reference region;
determining a color correction model by calculating root polynomial expansion of said least-squares;
applying said color correction model on said color values by calculating root polynomial expansion of said color values to obtain normalized values; and
determine level of said urine parameters in accordance with normalized values.

2. The method according to claim 1 wherein said step extracting reference values includes converting said reference values to floating point values.

3. The method according to claim 1 wherein said step of conducting a regression analysis includes multiplying reference matrix including said reference values with an inverse of an expected matrix including said prestored set of values to obtain correction matrix representative of said color correction model.

4. The method according to claim 3 wherein said correction matrix is calculated as:
exp(Mₜ)^{T}*(Mᵣ^{T})⁻¹
where Mₜ is a matrix of said reference values and where Mᵣ is a matrix of said prestored set of values. Note that M^{T} is the transpose of matrix M and M⁻¹ is the inverse of M.

5. The method according to claim 3 wherein said step of applying said color correction model includes multiplying said correction matrix with root polynomial expansion of said color values, wherein said color values are RGB values and said root polynomial expansion is defined as: exp(RGB)=(R, G, B, \sqrt{R*G}, \sqrt{G*B}, \sqrt{R*B})^{T}.

6. The method according to claim 5 wherein said step of applying said color correction model is calculated as:
(M_{c}*exp(RGB)^{T})^{T}
where exp(RGB) is a matrix of root polynomial expansion of said color values and where M_{c} is said correction matrix.

7. The method according to claim 1 wherein said plurality of reference regions includes between five and thirty reference regions.

8. The method according to claim 1 further comprising neural networks training including comparing said normalized values with stored values and determining probability-weighted association between said normalized values and a predicted value of said urine parameters.

9. A system for conducting a urinalysis, the system comprising:
a urine strip having a plurality of reacting areas configured to react with a predetermine urine parameter, and a plurality of reference regions each having a designated color;
a mobile device configured to obtain an image of said urine strip and transmit said image;
a remote server configured for receiving said image from said mobile device;
wherein said remote server includes a database including prestored set of values corresponding to expected colors of each reference region;
wherein said remote server further includes processing unit configured for:
extracting, from each reference region, reference values representative of at least one detected color in said reference region;
extracting, from each reacting area, color values representative of a detected color of said reacting area;
conducting a regression analysis by determining least-squares of the reference values in accordance with said prestored set of values;
determining a color correction model by calculating root polynomial expansion of said least-squares;
applying said color correction model on said color values by calculating root polynomial expansion of said color values to obtain normalized values; and
determine level of said urine parameters in accordance with normalized values.

10. The system according to claim 9 wherein said processing unit is further configured for converting said reference values to floating point values.

11. The system according to claim 9 wherein said processing unit is further configured for conducting a regression analysis includes multiplying reference matrix including said reference values with an inverse of an expected matrix including said prestored set of values to obtain correction matrix representative of said color correction model.

12. The system according to claim 11 wherein said correction matrix is calculated as:
exp(Mₜ)^{T}*(Mᵣ^{T})⁻¹
where Mₜ is a matrix of said reference values and where Mᵣ is a matrix of said prestored set of values.

13. The system according to claim 11 wherein applying said color correction model includes multiplying said correction matrix with root polynomial expansion of said color values, wherein said color values are RGB values and said root polynomial expansion is defined as: exp(RGB)=(R, G, B, \sqrt{R*G}, \sqrt{G*B}, \sqrt{R*B})^{T}.

14. The system according to claim 13 wherein applying said color correction model is calculated as:
(M_{c}*exp(RGB)^{T})^{T}
where exp(RGB) is a matrix of root polynomial expansion of said color values and where M_{c} is said correction matrix.

15. The system according to claim 9 wherein said plurality of reference regions includes between five and thirty reference regions.

16. The system according to claim 9 wherein said strip include a background having a dark or black color.

17. The system according to claim 9 wherein said server is further configured neural networks training including comparing said normalized values with stored values and determining probability-weighted association between said normalized values and a predicted value of said urine parameters.

18. The system according to claim 9 wherein said server includes an image database including a plurality of classified images of said reacting area classified by levels of said of said urine parameters, said server is configured to extract characterizing features of said classified images and to determine level of said urine parameter in accordance with said characterizing features.
